(19) United States
(12) Patent Application Publication
(10) Pub. No.: US 2007/0156681 A1
(43) Pub. Date: Jul. 5, 2007

(54) Multiple target object-based navigation

(75) Inventor: Ilja Fischer, Bad Schoenborn (DE)

Correspondence Address: KENYON & KENYON LLP, 1500 K STREET N.W., WASHINGTON, DC, 20005, US

(73) Assignee: SAP AG

(21) Appl. No.: 11/319,423

(22) Filed: Dec. 29, 2005

(51) Int. Cl. G06F 17/30

(52) U.S. Cl. 707/6

(57) ABSTRACT

The present invention provides a method for allowing object-based navigation between business objects and applications where multiple target applications may be opened by a user when the user selects a navigation element based on the use context in which the operation is performed.

### BACKGROUND

Object-based navigation (OBN) is a way of navigating between components of a complex system, such as a business management system. In such a system, a user accesses functions and components of the system via applications that display instances of business objects. As a specific example, an application provides a user access to an order management system, whereby selecting a field displayed in an instance of a business object, such as a customer, order, or contract, allows a user to view and manipulate information about that business object instance. Accessing an instance of a business object via an application makes it possible for a user to manipulate information stored in a business object, for example by viewing and modifying outstanding orders within an instance of a sales orders business object.

FIG. 1 shows a navigation process in a system implementing object-based navigation. A user 101 accessing an application 110 performs an operation, for example by selecting a field 122. The source object or view 120 may be a compilation of system information, business objects, and other related information. An object 120 displayed by a source application 110 may display fields 121 and 122. These fields may be, for example, customer names, account numbers, or other information. Each field may be a business object instance, or it may be part of the business object instance being displayed by an application. When a user selects a field 122, he navigates to a target application 130.

When a user selects a field displayed in an application view, he navigates to a new application, business object, or both. In FIG. 1, when a user selects a field 122 in the source application 110, he navigates to a target application 130. The target application 130 displays objects 140, fields 141 and 142, and other information.

Generally, and as described with respect to FIG. 1, when a user selects a field in an OBN application the user navigates to a target application. However, the user may wish to access multiple target applications based on the same operation in the source application. There is therefore a need for a system and method allowing for navigation to multiple target applications in an OBN system based on the context in which an operation is performed.

### BRIEF DESCRIPTION OF THE DRAWINGS

FIG. 1 is a block diagram illustrating object-based navigation between applications.

FIG. 2 is a block diagram illustrating object-based navigation between applications according to an embodiment of the invention.

FIG. 3 is a flowchart illustrating a navigation process according to an embodiment of the invention.

FIG. 4 is an illustration of a system implementing object-based navigation according to an embodiment of the invention.

FIG. 5 shows a system implementing object-based navigation according to an embodiment of the invention.

### DETAILED DESCRIPTION

The present invention provides a method for allowing object-based navigation between business object applications where a user may access multiple target applications from a single operation performed in a source application.

An application such as a sales management application may display a business object or view having fields that a user can select to navigate to a target application using object-based navigation. The source (first) business object and/or application may be the same as the target business object and/or application, or it may be different. According to the present invention, multiple target applications may be accessed based on criteria such as the source business object, the user's role, and the operation performed. The operation performed by the user may depend on, for example, the field or business object selected and the source application from within which it was selected. For example, a business object instance of a “contract” object selected in a customer relations application may represent a different operation than the selection of an instance of the same business object in an supply chain management application.

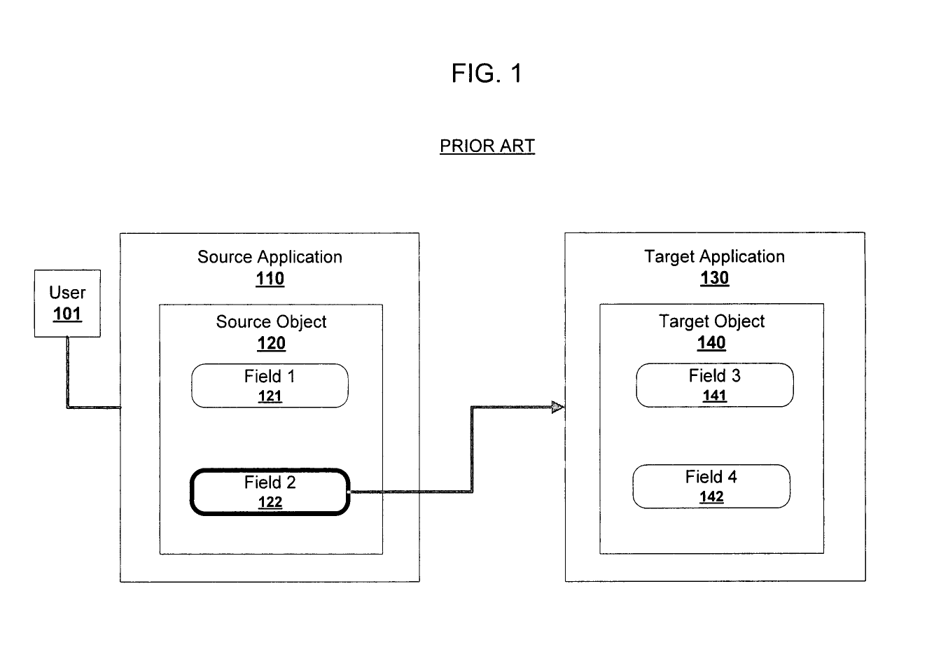

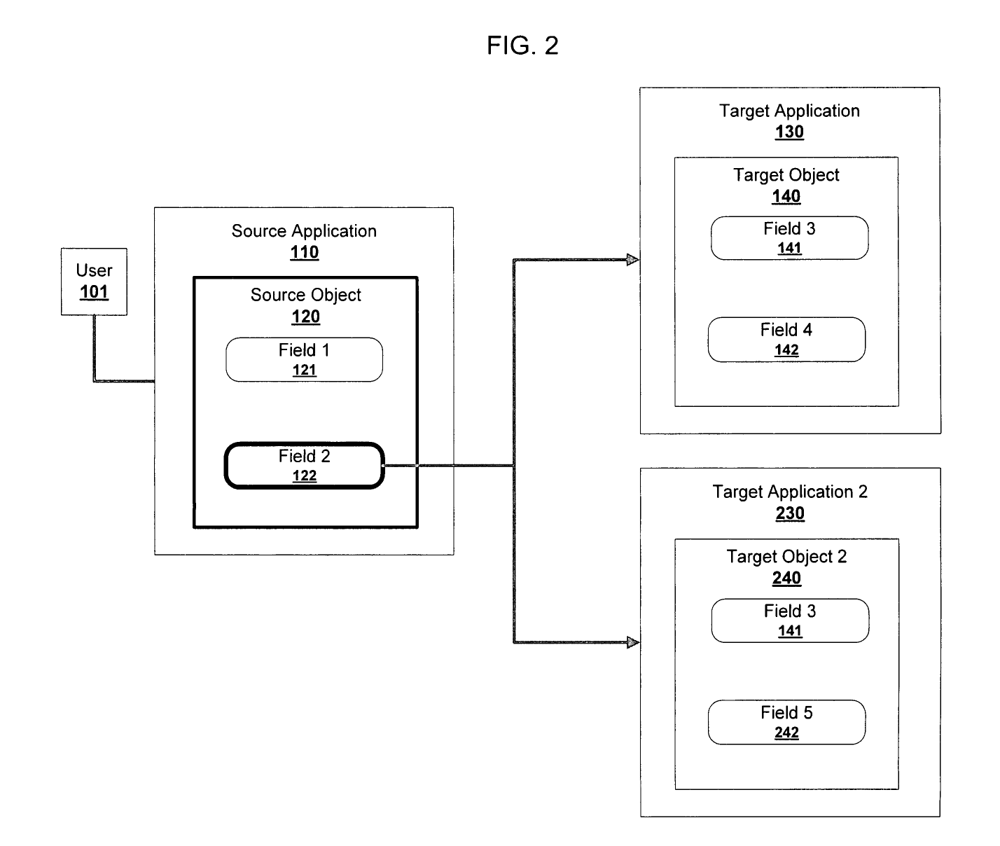

In the example described with respect to FIG. 1, a user is not able to access or open multiple target applications by performing a single operation in the source application and business object. FIG. 2 shows an example of object-based navigation that allows for opening multiple target applications according to the present invention. A user who selects Field 2 (122) in a source application 110 may be directed to multiple target applications 130 and 230. The specific applications shown when a user selects a field 122 may depend on the user's role, the business object selected, and the performed invoked by the user. As an example, a user may select a business object instance 120 such as a business partner in a source application 110 listing active contracts. The system may then open multiple target applications 130 and 230, such as a business partner application 130 and an invoicing application 230. These applications may be, for example, the applications which the user or a system designer determined to be the most closely-related to the source application 110 and business object 120. Other criteria may be used to determine which target applications will be invoked by a user operation performed in a source application.

The applications opened when a user selects a business object instance may be determined by the operation performed by the user, the user's role in the system, and the business object accessed by the user. Relationships between user operations, user roles, and business objects may be previously-defined by a user or developer. The relationships may specify that for certain use contexts, multiple applications should be opened. The use context may depend on combinations of user operations, user roles, and business objects. Similarly, the relationships may specify that only a single application is to be opened. For example, a flag may be included in the relationships that specifies that multiple applications should be opened in parallel. A combination of user role, operation, and business object that matches a relationship having such a flag will result in multiple target applications being opened. Such flags and/or relationships may be stored in metadata of business objects, or they may be stored externally such as in a database.

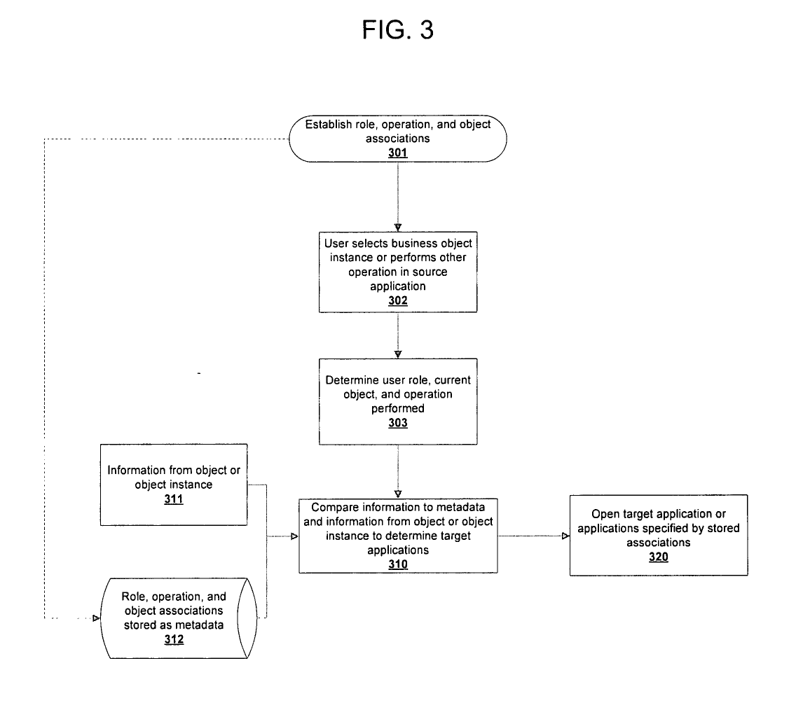

FIG. 3 shows an example navigation process according to an embodiment of the invention. A set of relationships between user roles, operations, and business objects may be created at the time a system is designed 301. These relationships may be stored as business object metadata 312, or they may be stored in an external system such as a database. When a user performs an operation such as selecting a business object instance 302, the system may determine the use context in which the operation was performed. The use context may depend on the user's current role, the business object being accessed, and the operation being performed 303. This information may then be compared 310 to the previously-created metadata 312, as well as information that may be sent by the business object accessed by the user 311. The information sent by the business object may include, for example, a flag specifying that multiple applications specified by the stored relationships should be opened in parallel. If the user's role, the business object accessed by the user, and/or the operation performed by the user 320 match a stored relationship, the user may be directed to a target application specified by the relationship. If the matching relationship indicates that multiple target applications should be opened, the user may be directed to two or more target applications in parallel. For example, if the system is accessed via a windows-based operating system, each target application may open in a separate window. Similarly, if the user accesses the system via a web browser, each application may be opened in a frame displayed in a browser window. Other methods of opening multiple applications may be possible. The target application or applications specified in each relationship may depend on one, some, or all of the data described.

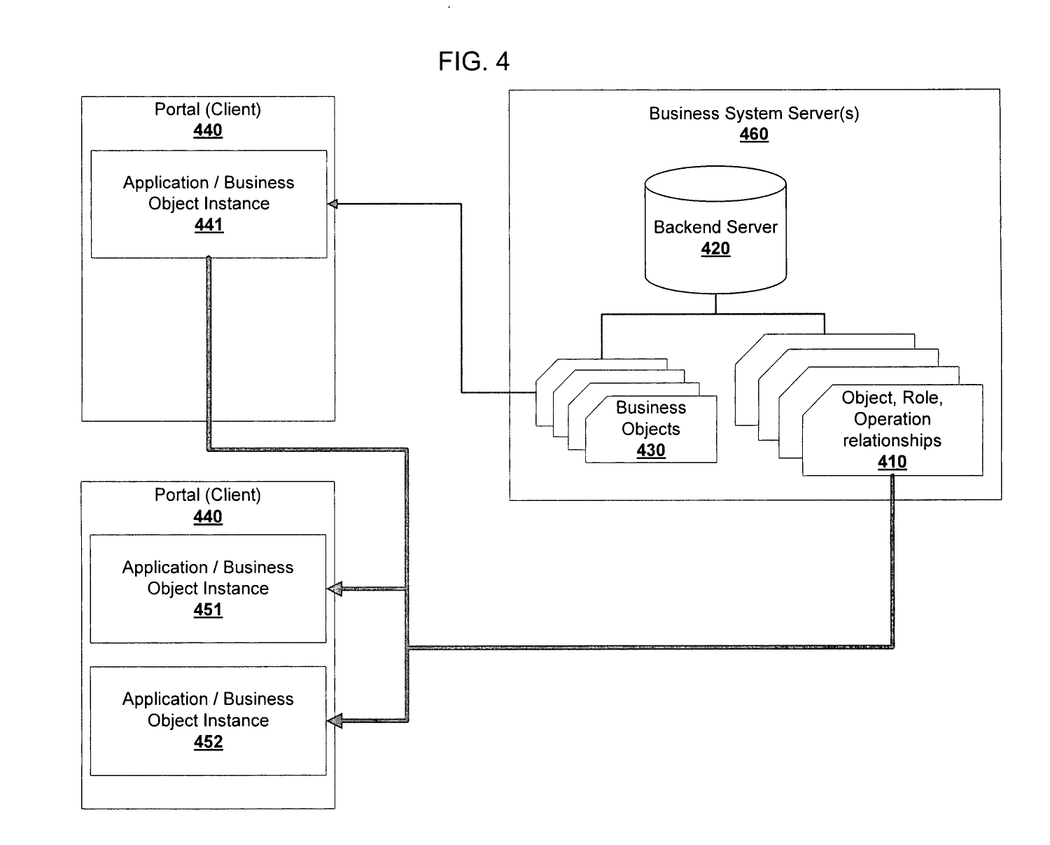

The relationships between roles, applications, and business objects may be stored as metadata in the business objects, or they may be stored separately, such as in a database. When a user selects a navigation element, a system according to the present invention may select a relationship from among the stored relationships that matches the user's role, the business object being accessed, and the operation being performed. An example of such a system is illustrated in FIG. 4. A business system 460 may store multiple business objects 430, which may contain a set of relationships 410 describing target applications for various combinations of user roles, operations, and business objects. The relationships 410 may be stored in metadata of the business objects 430, or they may be stored elsewhere in the business system 460 such as a database 420. A user may view an application 441 containing business object instances and other information via a portal 540. The portal 540 may reside on the user's client computer or application; the business system 560 may run on or contain one or more servers. Each business object or application may present navigation options to the user. For example, a business object displayed in an application may allow the user to select a navigation element such as a field displayed in the business object in order to view a different business object or open a different application. Similarly, other operations may be performed by a user accessing a business object or application 441. When a user selects a navigation element, for example by selecting a field in a business object instance 441, the system may compare the relationships 410 stored in the system to the use context in which the operation was performed to determine appropriate targets for the navigation. If the relationship 410 appropriate to the user's role, the business object being accessed, and/or the operation being performed specifies multiple target applications, the system may open those applications 451, 452 when the navigation element is selected. The portal 440 may then display the applications or business objects 451, 452 described by the appropriate relationship. Each relationship 410 may include one or more target applications that the system will open or invoke when the relationship is matched to an operation performed by a user. The relationships 410 may be previously defined by a user, for example when the navigation of the business system 460 are designed.

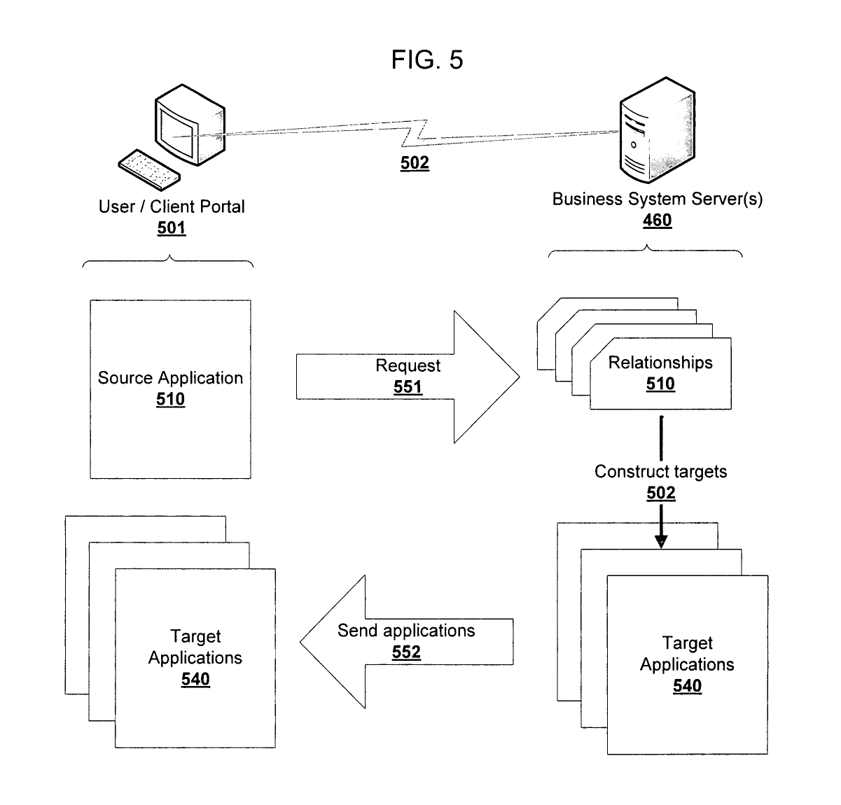

In some embodiments of the invention, the user may access applications stored and executed on one or more business system servers via interfaces shown in a portal. For example, the portal may be a web browser accessing web pages created by the business system. Multiple application interfaces may be displayed in a portal, such as by displaying each interface in a frame within the same browser window. Similarly, each application may be displayed in a separate browser window. An example embodiment of the invention in which application interfaces are created by a business system and transmitted to the user is shown in FIG. 5. A user may access one or more servers in a business system 460 via a client system 501. The client and server(s) may communicate via a communication network 502. The topology, architecture, and related protocols of the communication network 502 are immaterial to the present invention unless otherwise specified herein. When a user accesses the business system via a portal such as a web browser, application interfaces may be transmitted to the portal. As shown in FIG. 5, a source application interface 510 may be displayed within the portal. More than one application interface may be displayed on the client computer, to allow the user to access multiple applications or perform multiple tasks at the same time. When a user selects a business object instance, navigation element, or other object in the source application interface, a request may be transmitted (551) from the client 501 to the business system 460. Based on relationships 510 stored in the business system, the business system may construct (502) one or more target application interfaces. The relationships may specify one or more target applications depending on criteria such as the user's role, the operation performed by the user, and the business object instance used to perform the operation. The relationships may be stored as metadata in business objects stored in the business system 460, or they may be stored in any other appropriate medium such as a database. The target application interfaces may be web pages containing business object instances, navigation elements, and other objects. These target application interfaces 540 may then be transmitted (552) to the client 501 and displayed on the portal. The target application interfaces may be displayed, for example, in separate frames in a web browser, or in any other appropriate manner such as in separate browser windows.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for object-based navigation, comprising:
in response to a user operation in a source application, comparing at least one of the user's role, the operation performed, and a source business object used to perform the operation to a set of relationships between user roles, operations, and business objects; and
if a relationship matching at least one of the user's role, the operation performed, and the source business object specifies multiple target applications, opening those applications specified by the relationship.

2. The method of claim 1, wherein the relationship are stored in metadata of business objects.

3. The method of claim 1, wherein the relationships are defined by a user.

4. A machine-readable medium containing program instructions for execution on a processor, which when executed by the processor cause the processor to perform:
in response to a user operation in a source application, comparing at least one of the user's role, the operation performed, and a source business object to a set of relationships between user roles, operations, and business objects; and
if a relationship matching at least one of the user's role, the operation performed, and the source business object specifies multiple target applications, opening those applications specified by the relationship.

5. The machine-readable medium of claim 4, wherein the relationships are defined by a user.

6. The machine-readable medium of claim 5, wherein the relationships are stored in metadata of the business objects.

7. A system comprising:
a business system comprising a plurality of relationships, each relationship defining one or more target application interfaces for a combination of at least one of a user role, an operation, and a business object; and
a portal to display application interfaces;
wherein at least one of the plurality of relationships specifies more than one target application; and
wherein a target application interface is transmitted to the portal in response to an operation by a user.

8. The system of claim 7 wherein the relationships are stored in metadata of business objects.

9. The system of claim 7 wherein the relationships are defined by a user.

10. A navigation method for portal sessions, comprising, at a server:
receiving a resource request from a client representing user interactivity with a navigation element of a rendered page of information within a portal session,
determining a use context of the portal session,
based on the selected navigation element and the use context, generating at least one new portal page having at least one target application based on the selected navigation element and the use context, and
transmitting the at least one page to the client.

11. The method of claim 10, wherein the resource request explicitly defines the use context.

12. The method of claim 10, wherein the resource request is generic across different use contexts and use context data is maintained by the server from prior interaction with the client.

13. The method of claim 10, wherein the use context represents a user role defined for portal sessions.

14. The method of claim 10, wherein the use context represents an operation initiated by the user, executing on the server for which the portal session is active.

15. The method of claim 10, wherein the use context represents a business object currently active within the portal session.
